(19) United States
(12) Patent Application Publication
(10) Pub. No.: US 2005/0156125 A1
(43) Pub. Date: Jul. 21, 2005

(54) Method and apparatus for managing imaging system workflow

(75) Inventors: Joseph R. Rimsa, Palo Alto, CA (US); Christopher R. Mitchell, Pleasanton, CA (US); Karl Minser, Los Gatos, CA (US); Charles Cantoni, San Ramon, CA (US)

Correspondence Address: HELLER EHRMAN LLP, 275 MIDDLEFIELD ROAD, MENLO PARK, CA, 94025-3506, US

(73) Assignee: ALARA, INC., Fremont, CA (US)

(21) Appl. No.: 10/998,292

(22) Filed: Nov. 26, 2004

Related U.S. Application Data
(60) Provisional application No. 60/525,611, filed on Nov. 26, 2003.

(51) Int. Cl. G03B 42/08

(52) U.S. Cl. 250/584

(57) ABSTRACT

A method and system is provided for improving and organizing workflow of a computed radiography system comprising of one or more storage phosphor readers, and multiple workstations which control and receive image data from the readers. In one embodiment, the method comprises temporarily associating an imaging cassette, containing a storage phosphor imaging plate, with a specific workstation. The imaging cassette is transported to the reader and inserted into the reader. The image plate reader is temporarily associated with the specific workstation. This temporary association allows the workstation to control the reader; and allow for sending of an X-ray image data from the reader only to the specific workstation. In other embodiments, this workflow may be adapted for use with networks having a plurality of image plate readers and a plurality of workstations.

### CROSS-REFERENCE TO RELATED APPLICATIONS

The present application claims the benefit of priority to co-pending U.S. Provisional Application Ser. No. 60/525,611 (Attorney Docket No. 39315-0081) filed Nov. 26, 2003. This application is incorporated herein by reference for all purposes.

### BACKGROUND OF THE INVENTION

1. Field of the Invention

This invention relates to radiographic imaging and more specifically to efficient management of workflow associated with computed radiography (CR).

2. Description of Related Art

Computed radiography (CR) imaging systems are an established means for digitally acquiring, processing, storing, and displaying medical radiographic images. Commercially available CR systems comprise a wide range of image throughput and sale price. In general, larger, more expensive systems are able to achieve higher effective throughput through the use of a cassette loader allowing the user to load multiple cassettes into the machine without waiting. Single-plate CR readers are typically less expensive than multiple plate readers, but are not able to support the image throughput of the larger systems since an operator must wait for the previous imaging cassette to be ejected prior to inserting the next cassette. Because multiple plate CR readers have higher throughput, they are typically used to simultaneously support multiple X-ray rooms. However, if a CR reader supporting a large number of X-ray rooms becomes inoperative, than the negative impact on workflow is great.

Significant advantages would accrue if a less expensive single-plate CR reader could be deployed in such a way as to support the workflow of the more expensive, larger multi-plate readers. Moreover, because of the lower cost, deploying multiple readers would not be prohibitively expensive, and would provide backup should one reader become inoperative.

Current medical radiographic imaging practice combines a quality control (QC) computer workstation with the CR reader. Among other things, the QC workstation may provide the ability to enter and/or retrieve patient information, retrieve radiographic procedure orders, control the CR reader, and perform quality control tasks after the image is acquired. Examples of these tasks include: checking that the image correctly captured the anatomy of interest, ensuring that the X-ray technique used was appropriate, confirming the presence of orientation markers in the image, correctly orienting the image, and applying any necessary adjustments to the image display. For such configurations, the QC workstation and the CR reader remain dedicated to a single study until that study is completed. In situations where multiple radiographic procedures are underway at the same time, there is potential for bottlenecks and workflow delays and inefficiencies.

### SUMMARY OF THE INVENTION

Accordingly, one object of the present invention is to provide improved workflow configurations for computed radiography systems.

Another object of the present invention is to improve system throughput by providing systems that distribute or breakup the bottlenecks/time-consuming steps associated with computed radiography workflow.

Another object of the present invention is to provide devices and methods for tracking the origin of image plates and destination of images obtained from the plates.

Another object of the present invention is to provide devices and methods for creating associations between image plate cassettes and workstations.

Yet another object of the present invention is to provide a storage phosphor system, and the methods of use, that use an improved image plate workflow and has multiple QC workstations.

Still a further object of the present invention is to provide methods to organize workflow where the computed radiography system consists of multiple computed radiography readers and multiple workstations.

At least some of these objects are achieved by some embodiments of the present invention. The ability to increase the efficient usage of lower cost CR devices may motivate high patient volume institutions to consider deploying multiple lower cost systems. Advantages of scalability, portability, and redundancy would accrue. Moreover, the scalability of the present invention will allow lower volume institutions to implement CR and scale with volume demands as required.

In one embodiment of the present invention, a method is provided for organizing workflow for a computed radiography system. The method is designed for use with a single computed radiography reader capable of receiving an imaging cassette, and a plurality of computer workstations connected to the reader. The method comprises temporarily associating an imaging cassette, containing a storage phosphor imaging plate, with a specific workstation. The imaging cassette is transported to the reader and inserted into the reader. The image plate reader is temporarily associated with the specific workstation. This temporary association allows the workstation to control the reader; and allows for sending of X-ray image data from the reader only to the specific workstation. In other embodiments, this workflow may optionally be adapted for use with networks having a plurality of image plate readers and a plurality of workstations.

In another embodiment of the present invention, a computed radiography system is presented that can associate image plate cassettes with workstations. The system comprises at least one computed radiography reader and a plurality of computer workstations networked to the reader. The imaging cassette may optionally have an identifier on the cassette. A first reader is configured to recognize the identifier and temporarily associate the imaging cassette with a specific workstation. In some embodiments, the first reader is located geographically close to the workstation. The present invention includes a second reader on the reader configured to recognize the identifier. Based on information gathered by the second reader, the reader is configured to determine which workstation is associated with the identifier and to establish a connection with the workstation to send image data from the reader. It should be understood that in some embodiments, the identifier is a bar code. In other embodiments, the identifier may optionally be a number or word that a user manually enters into the workstation or the image plate reader to create the association.

In yet another embodiment, the present invention allows multiple X-ray rooms to be simultaneously served by a single reader. The present invention improves performance by addressing the problem, where with more than one QC workstation, the users depend on each other to use the one workstation and next user cannot use it until the current user is finished. The present invention spreads out the bottleneck by having multiple workstations. In one embodiment, solving that problem also involves keeping track of the patients, their image plates, and destinations of scanned images. The present invention may optionally comprise of tracking of a single image independent of where it is read and have the image data sent to an originating station or other destination based on the temporary association created.

In another aspect, the present invention provides methods for temporarily associating an image plate with a scanned image destination. In one embodiment, the method comprises associating an imaging plate with one of said destinations, capturing an image on the imaging plate, reading an identifier on the imaging plate to determine where to send the image on the imaging plate; using a reader to extract the image from the imaging plate, and sending the image to the desired destination.

In yet another aspect, the present invention associates QC workstations with imaging plates. In one embodiment, the invention comprises QC workstations associated with a single reader. Embodiments of the invention may optionally comprise various means of associating images to imaging plates and images to destinations and QC station associated with them. Embodiments of the present invention may also involve a scan at the technician site (source) and at the reader site (scan). In some embodiments, a further scan (destination) if the final destination is not the technician.

The present invention may improve on known systems since instead of a technician having a QC workstation at the reader that has studies from multiple users interlinked and displayed, the technician has a workstation that just brings up just one user's studies. The workflow is improved and is patient centric.

The present invention may also provide the ability to have one reader servicing multiple sources, such as but not limited to at least two, at least three, or at least four X-ray rooms or X-ray exposure machines. The reader of the present invention does not have to run the imaging plates sequentially for a single patient; the reader can be used for any other cassettes that are coming in from multiple sources.

In one embodiment of the present invention, through the use of bar codes on the imaging cassettes and the creation of associations between a cassette and a workstation, the reader will know where to send image data obtained from the imaging cassette when the cassette is processed by the reader. This allows for mutual sharing of a reader among multiple users with multiple workstations since the reader will always know where to send the image it is reading off of the imaging cassette. The ability to route the image data to any one of a number of workstations coupled to the reader will allow for improved utilization of the reader. It allows the reader to easily service multiple workstation. In some embodiments, after the reader finishes reading a cassette, it or some other device may optionally delete the association between the imaging cassette and the workstation. Optionally, in other embodiments of the invention, the association may persist until a new association is created. In some embodiments, when a new association is created, a broadcast message may be sent to other workstations and/or the reader to ignore or delete previous associations for this particular cassette and use the new association being created. Some association may be time dated so that the age of an association may be determined and only the newest is relied upon.

A further understanding of the nature and advantages of the invention will become apparent by reference to the remaining portions of the specification and drawing.

### BRIEF DESCRIPTION OF THE DRAWINGS

FIG. 1 shows one embodiment of the present invention. PATENT

FIG. 2 shows a schematic showing one method of the workflow according to the present invention.

FIG. 3 shows another embodiment of the system according to the present invention.

FIG. 4 shows a still further embodiment of the system according to the present invention.

FIG. 5 shows a cassette with an identifier.

FIG. 6 is a schematic showing one workflow according to the present invention.

FIG. 7 is a schematic showing another workflow according to the present invention.

FIG. 8 shows a schematic of one system according to the present invention.

### DESCRIPTION OF THE SPECIFIC EMBODIMENTS

It is to be understood that both the foregoing general description and the following detailed description are exemplary and explanatory only and are not restrictive of the invention, as claimed. It may be noted that, as used in the specification and the appended claims, the singular forms “a”, “an” and “the” include plural referents unless the context clearly dictates otherwise. Thus, for example, reference to “a material” may include mixtures of materials, reference to “a bar code” may include multiple bar codes, and the like. References cited herein are hereby incorporated by reference in their entirety, except to the extent that they conflict with teachings explicitly set forth in this specification.

In this specification and in the claims which follow, reference will be made to a number of terms which shall be defined to have the following meanings:

“Optional” or “optionally” means that the subsequently described circumstance may or may not occur, so that the description includes instances where the circumstance occurs and instances where it does not. For example, if a device optionally contains a feature for having a cassette loader, this means that the cassette loader feature may or may not be present, and, thus, the description includes structures wherein a device possesses the cassette loader feature and structures wherein the cassette loader feature is not present.

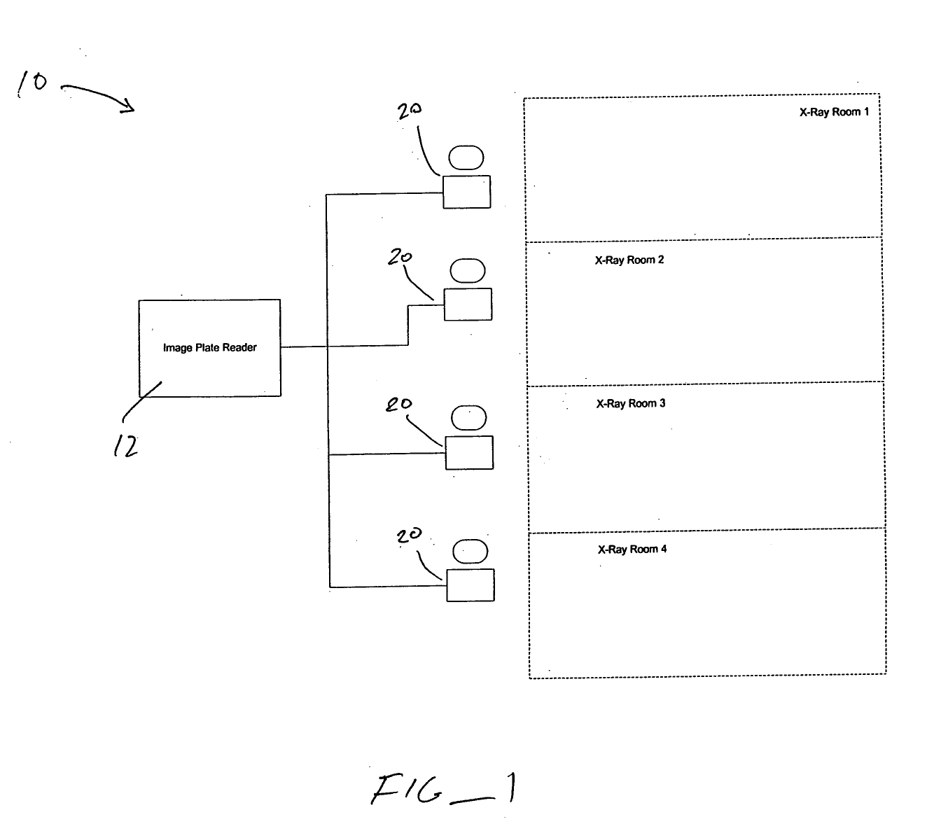

Referring now to FIG. 1, a first embodiment of a computed radiography system 10 according to the present invention will now be described. In this embodiment, the present invention comprises a single computed radiography image plate reader 12 and a plurality of computer workstations 20 networked or otherwise in communication with the reader or reader 12. Although not limited to the following, each workstation 20 may be associated with an X-ray room or radiology station. Each workstation 20 may be located inside the X-ray room or alternatively, each workstation 20 may be located in close proximity to such a room. In this particular embodiment, there are four X-ray rooms and at least four workstations 20. The reader 12 is designed to handle one image cassette at a time. By way of example and not limitation, the workstations 20 may optionally be used to control the reader 12 and receive image data from the reader. This allows data from the image or storage plates to be scanned or extracted by the reader 12 and sent to the proper destination. In this embodiment, the workstations 20 function as quality control (QC) workstations where a technician or user can verify the right information was obtained, that the image is oriented correctly with the correct patient anatomy, or the like. Having multiple QC workstations 20 frees up the reader 12 to begin processing other image plates while quality control is performed on images sent from the reader 12.

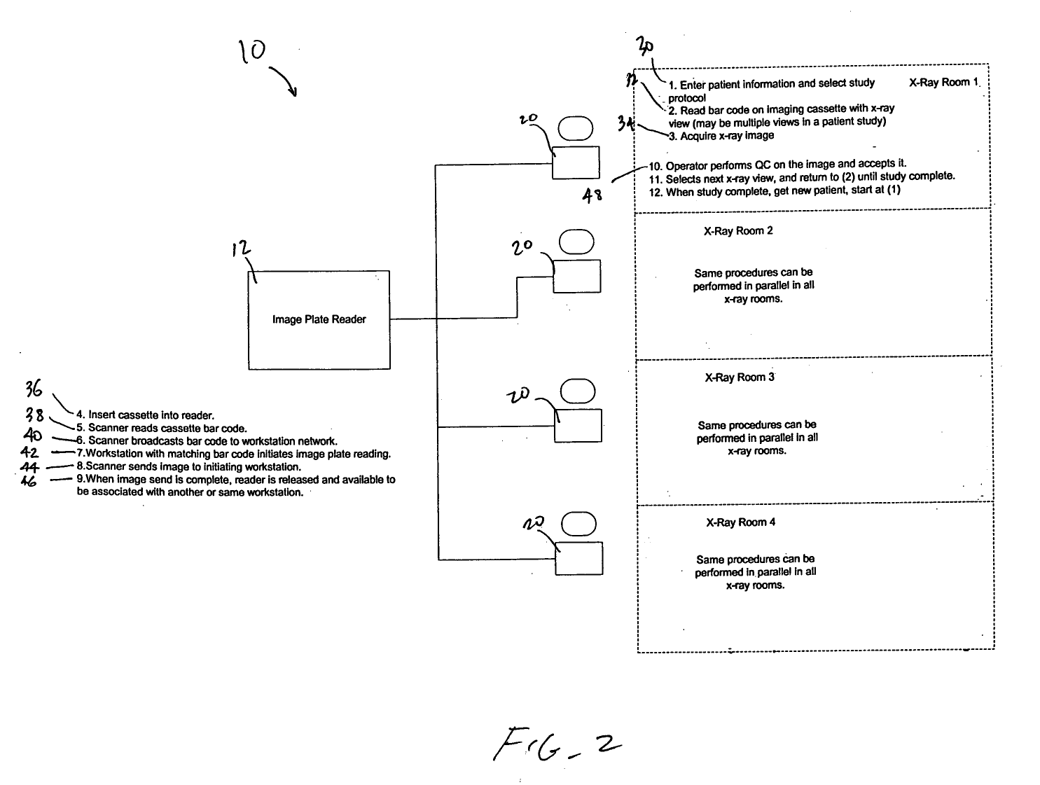

Referring now to FIG. 2, a workflow for managing image plates in the system 10 will now be described. In the embodiment shown in FIG. 2, the first step 30 comprises entering patient information and selecting a study protocol. At the next step 32, the X-ray technician may use a device to read an identifier such as, but not limited to, a bar code on the cassette holding the image plate with an X-ray view. This creates a temporary association between the cassette and this X-ray room location or the workstation 20 associated with the X-ray room. This associates an origin with the image plate 42 and lets the reader 12 know where to send the X-ray image on any particular image plate. The technician then positions the plate and acquires an X-ray image at step 34.

Continuing with this embodiment of the workflow, after exposing the image plate to X-rays, the technician will take the image plate to the image plate reader 12. FIG. 2 shows where the steps are taking place relative to the location of the X-ray room and the reader 12. As mentioned, the image plate reader for this embodiment is a single cassette reader. The cassette holding the image plate is inserted into the reader 12 at step 36 and the reader 12 will identify the cassette based on the bar code or other identifier at step 38. In this embodiment at step 40, the reader 12 will broadcast the bar code or identifier to the network of workstations 20. It should be understood that in other embodiments, other methods may optionally be used such as but not limited to having the reader look to a database or lookup table to find which identifier is linked with which workstation. In the present embodiment, the workstation 20 temporarily associated with or recognizing the bar code or identifier will initiate the image plate reading process at step 42. The reader 12 begins reading the image from the plate at step 44. The reader will then send the read image to the initiating workstation 20. When the image sending process is complete, the reader 12 may optionally be released and become available to be associated with another or the same workstation as indicated by step 46.

Meanwhile, back at associated workstation 20, the operator or technician will then perform quality control (QC) on the read image sent to the workstation 20 by the reader 12, as indicated at step 48. After accepting the image, if there are other views to take for the X-ray study, the technician may reposition the patient to continue the study. The above process continues until the X-ray study is completed. Concurrently, other X-ray rooms may also be in operation. The same procedures discussed above may be performed in parallel in the other X-ray rooms. As a nonlimiting example, the reader 12 may be processing an image plate for workstation 20 associated with X-ray room 1. As soon as the reader 12 has finished sending image data to X-ray room 1's workstation and the reader has received a new cassette, the reader 12 may begin processing another cassette from another X-ray room. The next image plate may be from X-ray room 3, any X-ray room with a workstation on the network, or the image plate may be from the same workstation. A temporary association is then created with a workstation 20 for that X-ray room and that workstation may then instruct the reader 12 to begin sending image data to that associated workstation. The cassette or image plate number or bar code, in this embodiment, is always associated with that cassette, and only temporarily associated with the X-ray room location. Although not limited to the following, the bar code may optionally be placed on the cassette housing the image plate or it may be on the image plate itself.

It should be understood of course, that other methods of identifying the imaging plates may also be used without departing from the spirit of the present invention. As nonlimiting examples, radio frequency (RF), infrared, optical, magnetic, audio, ultrasonic, and other techniques may optionally be used on the cassette to act as identifiers. Some embodiments may optionally use a ROM chip, RF chip, or other semiconductor device to handle the identification process. Any of these methods or combinations of such methods may optionally be used to associate information with each imaging plate. The information may optionally include but is not limited to: which workstation should control the reader 12, where the image plate came from, and/or where the image should be sent after it is obtained from the image plate. As seen, a variety of ways may be used to associate an image with a workstation so that the read image is sent to the desired station or destination from reader 12.

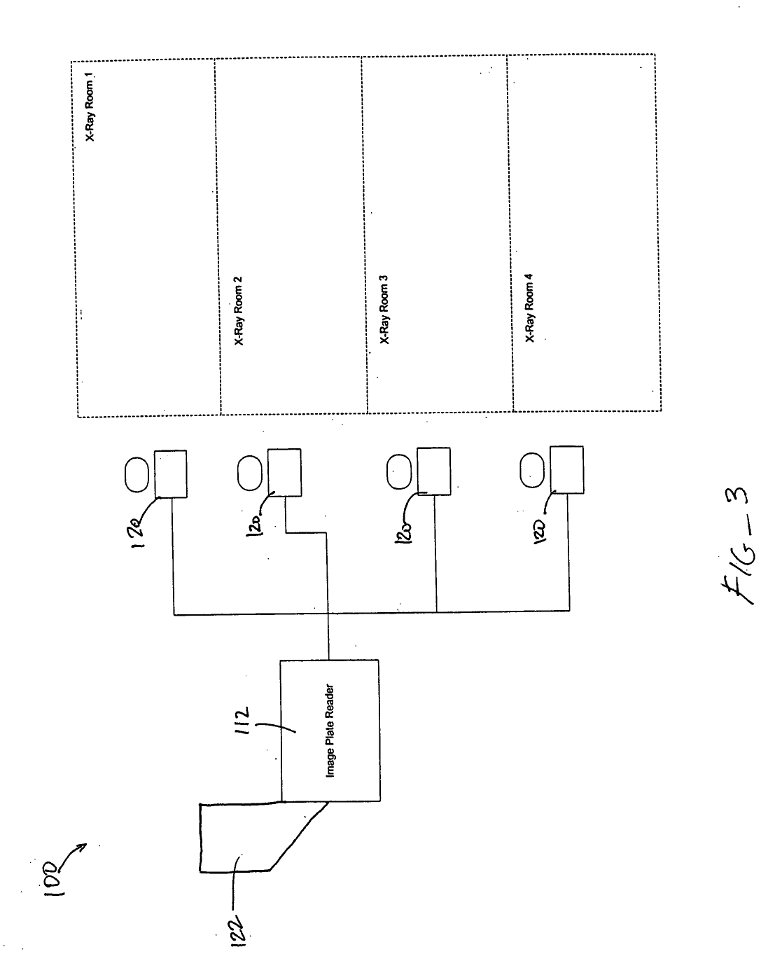

Referring now to FIG. 3, a second embodiment of a computed radiography system 100 according to the present invention will now be described. In this embodiment, the plate reader 112 may optionally include a cassette loader 122 on the reader 112. The cassette loader 122 can be used to hold multiple imaging plate cassettes that are waiting to be processed by reader 112. This allows a user to drop off the cassette and then return to the X-ray room without having to wait and manually feed the cassette into the reader. The cassette loader 122 can automatically load the image plate from the cassette into the reader 112. Again, a plurality of computer workstations 120 may optionally be networked or otherwise in communication with the reader 112.

It should be understood that a workflow method similar to that shown in FIG. 2 may be used with the system 200. One difference, however, is that instead of taking each image plate to the reader 112 after exposure to X-rays, the technician may optionally take several X-ray views and then bring several imaging plates to the reader at one time. This reduces the need to take the image plate to the reader 112 after each X-ray exposure. In this embodiment, each cassette may still have its own identifier or bar code so that the reader knows which workstation is associated with which cassette, in case the cassettes are interleaved in the cassette loader 122 with cassettes from other locations.

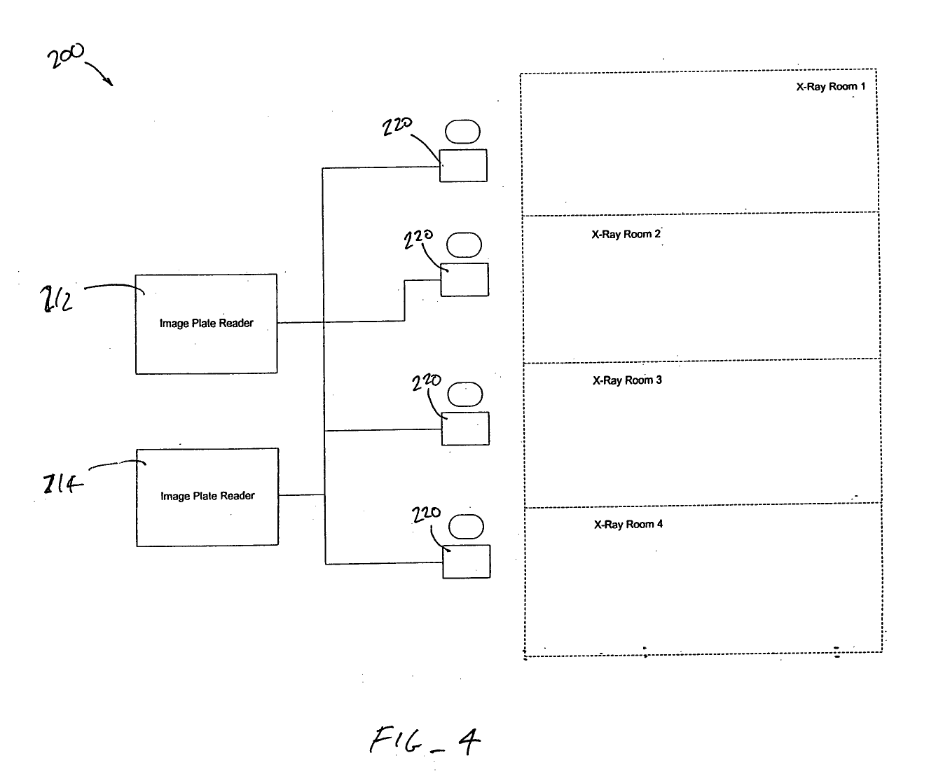

Referring now to FIG. 4, a third embodiment of a computed radiography system 200 according to the present invention will now be described. In this embodiment, the system 200 may include multiple image plate readers 212 and 214 on a single network. In theory, the system 200 is not limited to just two readers and four workstations, but instead, it could have M number of plate readers 212 and N number of workstations 220, where M and N are integers that may be greater than 2 and 4 respectively.

It should be understood that, in this embodiment, the system 200 may use a workflow similar to that shown in FIG. 2, except that, if one of the readers 212 is being used by one of the workstations 220, a user or technician may take the imaging plate to the second reader 214 for processing of that second image plate. Again the workflow associated with the system may be substantially the same as that shown in FIG. 2 where a bar code or identifier will be used by the reader 12 to determine which workstation will receive the image data reader from the imaging plate. At least one of the plate readers 112 may optionally include a cassette loader 122 on the reader 112. The cassette loader 122 can be used to hold multiple imaging plates.

For any of the embodiments discussed herein, having multiple QC workstations and X-ray room locations makes it desirable to keep track of or be able to associate a cassette/imaging plate with a workstation. In some embodiments, this may involve associating information to each cassette/imaging plate, where the information may include but is not limited to: which workstation the cassette/image plate came from and/or where the image should be sent after it is obtained from the image plate. The present invention provides a variety of ways to identify an image with a workstation so that the right image is sent to the right station or destination after being scanned at reader 12.

In one configuration, at each workstation 20 there may optionally be a bar code reader that would take that cassette or image plate number which is always associated with that cassette, and temporarily associate it with the patient data which is being collected and entered by the operator or retrieved from the hospital or radiology information systems (HIS/RIS). In one embodiment, the temporary association of the cassette/image plate to a particular destination is ended after the image has been received at the correct destination and after the image plate is erased to prepare for its next use. In other embodiments, the association may remain until a new one is created by reading the bar code at another QC workstation 20.

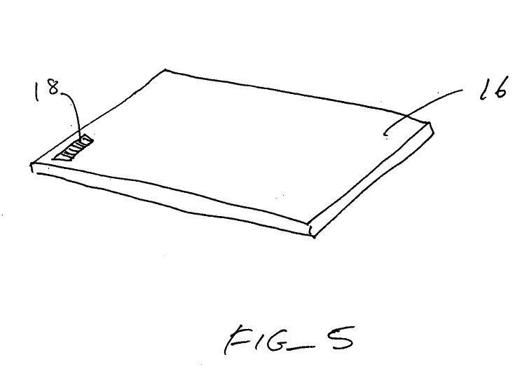

Thus, by having a cassette 16 with identifier 18 (see FIG. 5), a single reader 12 can serve multiple geographical location and process image plates from those locations in a sequential or non-sequential manner. In most embodiments, the reader 12 sends the image data to only one workstation. In other embodiments, a single reader 12 (upon recognition of certain codes) can send the image to multiple workstations 20 that may be at the same or at multiple geographical locations. As previously discussed, in some embodiments, multiple readers 12 may be used to serve multiple workstations and/or X-ray rooms.

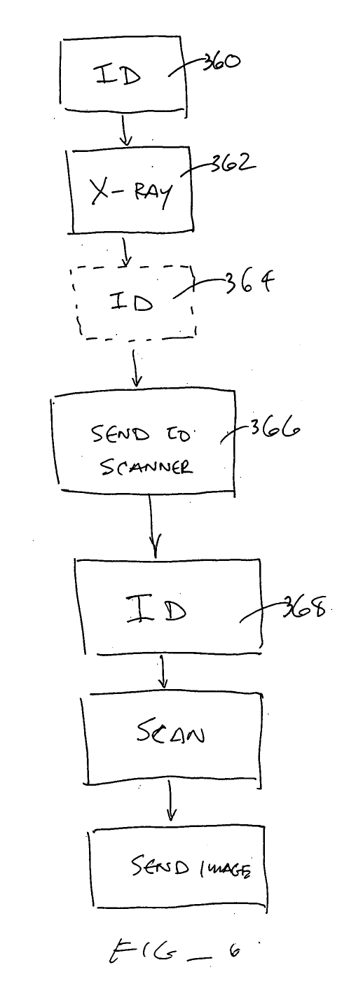

Referring now to FIG. 6, a schematic a workflow for use with some embodiments of a computed radiography system is shown. In this embodiment, the method involves an identification (ID) step 360 where, as a nonlimiting example, a bar code or identifier 18 may be scanned or otherwise determined. The ID step is used to create the temporary association between the cassette 16 and a specific workstation 20. The X-ray may then be taken as indicated by step 362. In some embodiments, step 364 (shown in phantom) may optionally involve taking the ID step after the X-ray image is captured. The image plate in cassette 16 is then read by the reader as indicated by step 366. The cassette 16 is identified at the reader location as indicated by step 368. Although not limited to the following, a bar code reader or other means of identification in the reader 12 or a handheld reader may be used to identify the cassette 16 prior to insertion into the reader 12, while it is in the reader 12, and/or after the plate leaves the reader 12. This identifier 18 may create a temporary association of the reader 12 with a specific workstation 20 and/or it may be used to tell the reader 12 where to send the read image. Conversely, the associated QC workstation may recognize when a cassette whose code is temporarily associated with that workstation. In this case, the workstation asserts control of the reader 12, and receives the read image data. As a nonlimiting example, the identifier 18 may indicate the destination or it may be used as a pointer to a database on the computer network which in turn holds a variety of information including but not limited to the destination or workstation associated with this particular identifier. The read image is then sent to the desired destination. Optionally, quality control may then occur at the destination.

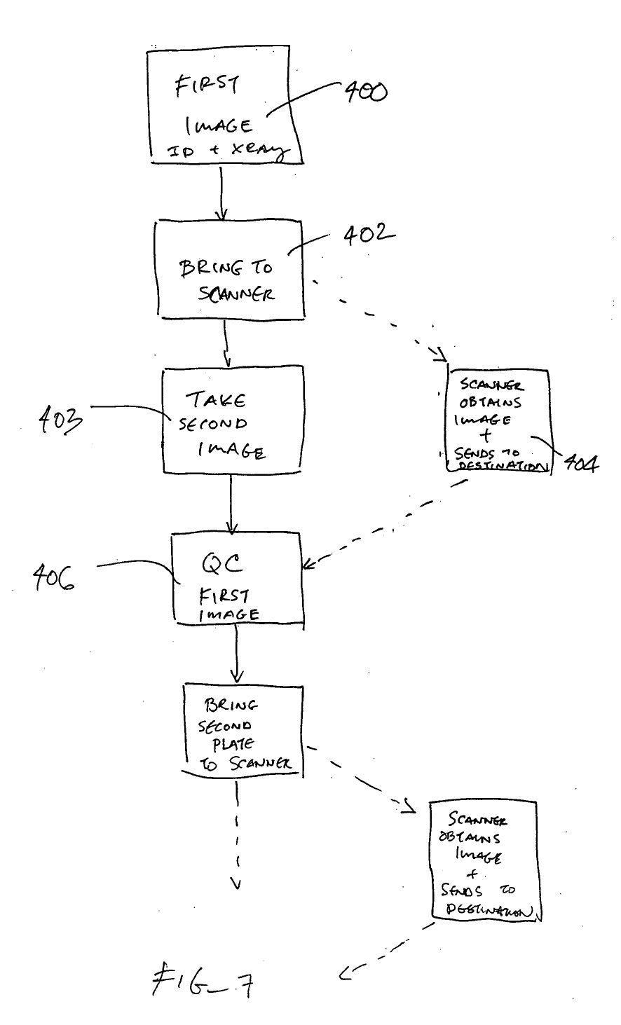

Referring now to FIG. 7, a still further embodiment of the workflow for using the reader 12 according to the present invention will now be described. The present embodiment provides the technician with the option of processing image plates during the patient's X-ray session. In this embodiment, as soon as the technician is done taking a first image and bar coding or otherwise creating a temporary ID association at step 400, the technician could place the cassette in the reader 12 at step 402 and then go back to the X-ray room and start positioning the patient for the next X-ray image at step 403. The reader 12 will obtain the image and send the read image to the correct destination as indicated by step 404. When the technician or operator is done with that second X-ray exposure, the technician can go to his workstation 20, perform quality control for the first image as indicated at step 406, and then drop off the second image plate at reader 12 at step 408. This allows the technician to perform quality control on the first image (now read by reader 12 and sent back to the QC station 20).

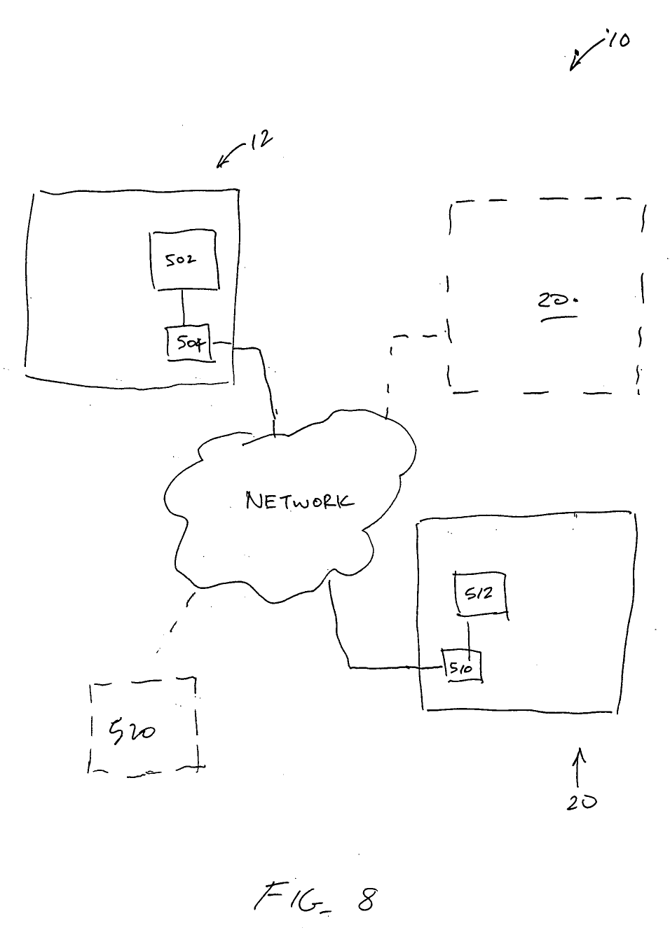

FIG. 8 is a schematic showing one embodiment of a system according to the present invention. The system 10 may include at least one reader 12 with a plurality of workstations 20 networked to the reader. In some embodiments, the readers and workstations can be connected directly, without a LAN or WAN therebetween, but generally there is a network connection. As seen in FIG. 8, the reader 12 may include a processor 502 for handling the image data obtained from the storage plate. The processor 502 may also be configured to accept commands from the workstation 20. The processor may any number of microprocessors as known in the art. A network card 504 or other network connection device is provided to allow communication with a workstation. In the present embodiment, communication between the reader 12 and a workstation 20 is via a network. The workstation 20 may also include a network card or other network connection device 510 and a processor 512 for handling receipt of the image data and/or for controlling the reader 12. As seen in FIG. 8, other workstations 20 (shown in phantom) may also be coupled to the reader 12 through the network. In one embodiment of the present invention, the processor 512 may be used to temporarily associate an imaging cassette with a specific workstation. In one embodiment, the processor 502 may be used for temporarily associating the image plate reader with the workstation 20 that is associated with the imaging cassette that is currently being read by the reader 12. In one embodiment, the processor 502 and network card 504 may be used for sending X-ray image data from the reader only to the associated workstation. In another embodiment, the processor 502 and network card 504 may broadcast an imaging cassette ID to the work and the workstation with the matching bar code initiates image plate reading. It should also be understood that the processor 512 may be used to create or modify a dataobject in a database to create an association or linkage between the imaging cassette and the associated workstation. The processor 512 may be used to process bar code data from the imaging cassette with the cassette ID. The processor 512 may also handle keyboard or other user entry identifying or entering the cassette ID. Some further embodiments may have a server 520 coupled to the network for storing ID data and/or images.

Workflows according to the present invention may have the following advantages. If for example, the first image is not acceptable for some reason, one can retake that image while the patient is still present in the clinic or radiology department. As soon as the technician is finished with the last image of a patient study, the technician can release the patient. The QC step may occur after each X-ray exposure, after several X-ray exposure, or after all X-ray exposures are made. The technician may perform quality control on one image, multiple images at a time, or all the images at one time.

For any of the embodiments above, it should be understood that having distributed QC workstations 20 allows for performance of quality control and patient management in parallel and removes a bottleneck in workflow. Bottlenecks at the reader 12 are minimized, since the reader 12 is only associated with a particular workstation for the time it takes to read and erase and image plate. QC activities are independent of the reader 12. In some embodiments of the present invention, there may be multiple readers on the same network. In a manner similar to that described for a single reader, the multiple readers are associated to a particular workstation via the bar code or identifier on the cassette or image plate.

For any of the embodiments above, reader 12 and workstations 20 of the present invention may be adapted for use in a variety of locations and for multiple configurations. In some embodiments, the destination of the scanned image may not be the X-ray room. For example, the present invention could be adapted for use in a doctor's office in a small clinic and instead of the QC workstations being in (or only being in) the X-ray room, the QC review stations may optionally be in a doctor's office or in multiple doctor's offices or locations.

Advantageously, embodiments described herein allow the preparatory work can happen in parallel. Additionally, the QC work on scanned images may also occur in parallel since the images are sent to workstations 20 where the technicians are located. Having multiple workstations allows technicians to view the images without having to wait for each other to perform quality control on an image before the reader 12 can process another image. The present invention allows for parallel processing of: 1) all the preparatory work for associating a cassette or set of cassettes or image plates with a particular patient study, 2) patient positioning and management and 3) performing quality control on the images. This keeps the information central to wherever the technician is located.

While the invention has been described and illustrated with reference to certain particular embodiments thereof, those skilled in the art will appreciate that various adaptations, changes, modifications, substitutions, deletions, or additions of procedures and protocols may be made without departing from the spirit and scope of the invention. For example, with any of the above embodiments, one may use identifiers other than a bar code. Any of the above embodiments may be used with a cassette loader to hold multiple imaging plates. In any of the above embodiments, the network connections between reader 12 and stations 20 may be wired or wireless. In any of the above embodiments, the present invention may optionally be adapted for use with a portable X-ray machine. In any of the embodiments above, the patient data may optionally be collected and typed in by the operator or retrieved from the hospital or radiology patient information system. In embodiments of the present invention, the imaging process is distributed as opposed to being localized only at the reader. Optionally, one or more QC workstations may also be included at the reader 12 location. Optionally, in other embodiments, the identifier 18 may be the destination of where the image is to be sent from reader 12 and this location may or may not be the same as the origin or the X-ray room (i.e. such as where the doctor or radiologist is located). It should be understood that in some embodiments, the reader may complete its scan of the image and then send the entire image to the associated workstation. Some embodiments may have the reader determine which workstation should receive the image during or after the scan process. In some embodiments, the workstation controlling the reader may be located in a distant location from where the X-ray was taken and connected over a wide area network such as the Internet. For any of the above embodiments, the storage plate may be configured to be stand alone device without a cassette with any identifier on the storage plate. In any of the embodiments above, a cassette may be configured to contain multiple storage plates which may be made of the same or different storage plate materials.

For any of the embodiments herein, the reader and workstation may be coupled over a wide area network (WAN) such as the Internet, or the like. In this embodiment, computer network may use communication protocols such as TCP/IP, RTP, RTSP, or the like for the transfer of data. In other embodiments, the reader and the workstation may optionally be on a local area network (LAN), based upon TCP/IP, IPX, or the like. Data communication may include transfer of HTML based data, textual data, form submissions, plug-in programs or viewers, applets, packetized audio or video data, real-time streaming data, and the like. Although computer network is illustrated as a single entity, as is the case with the Internet, it should be understood that computer network may actually be a network of individual computers and servers.

Although not limited to the following, a bar code or identifier reader may be used to identify the plate 42 prior to insertion of plate 42 into the reader 12, while it is in the reader 12, and/or after the plate leaves the reader 12. This identifier 18 may be used to tell the reader 12 where to send the scanned image. As a nonlimiting example, the identifier 18 may be used as a pointer to a database on the computer network which in turn holds a variety of information including but not limited to the destination associated with this particular identifier. It should be understood that the reader 12 and workstations 20 may also be coupled to a PACS system for archiving of images.

The publications discussed or cited herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. All publications mentioned herein are incorporated herein by reference to disclose and describe the structures and/or methods in connection with which the publications are cited.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Expected variations or differences in the results are contemplated in h the objects and practices of the present invention. It is intended, the invention be defined by the scope of the claims which follow and that interpreted as broadly as is reasonable.

1. A method for organizing workflow for a computed radiography system comprising a single computed radiography reader capable of receiving an imaging cassette, and a plurality of computer workstations connected to the reader, the method comprising:
temporarily associating an imaging cassette with a specific workstation;
transporting said imaging cassette to the reader;
inserting said cassette into the reader;
temporarily associating the image plate reader with the specific workstation that is associated with the imaging cassette that is currently being read by the reader, said temporary association allowing the workstation to control the reader; and
sending X-ray image data from the reader to the specific workstation.

2. The method of claim 1 further comprising:
releasing the reader from the associated workstation when image reading is complete.

3. The method of claim 1 wherein the temporarily associating step comprises scanning a bar code on the cassette.

4. The method of claim 1 wherein the imaging cassette contains at least one storage phosphor imaging plate.

5. The method of claim 1 further comprising broadcasting an ID of the imaging cassette over a network to the plurality of workstations to determine which workstation is associated with the imaging cassette.

6. The method of claim 1 wherein the temporarily associating an imaging cassette with a specific workstation comprises scanning a bar code on the cassette and associating the bar code with the specific workstation.

7. The method of claim 1 wherein the temporarily associating step comprises scanning a bar code on the cassette and associating the bar code with the specific workstation in a database, wherein the database is on the workstation or a central server coupled to a network coupling the workstations together.

8. The method of claim 1 wherein the temporarily associating comprises inputting ID information about the cassette into a computer and creating an association between that cassette and the specific workstation.

9. The method of claim 1 wherein temporarily associating the image plate reader with the specific workstation comprises establishing a communication link between the reader and the specific workstation.

10. The method of claim 1 wherein the specific workstation after being associated with the reader, instructs the reader to begin sending image data to the specific workstation.

11. The method of claim 1 wherein the X-ray image data from the reader is sent only to the specific workstation.

12. The method of claim 1 wherein workstations and the reader are coupled together over a wireless communication network.

13. The method of claim 1 wherein workstations and the reader are coupled together over a WAN or LAN communication network.

14. A method for organizing workflow for computed radiography system comprising a plurality of storage phosphor reading devices and a plurality of workstations, all of which are connected to one another on a network, the method comprising:
temporarily associating an imaging cassette, containing a storage phosphor imaging plate, with a specific workstation;
transporting said imaging cassette to one of said reading devices;
inserting said cassette into one of said reading devices;
temporarily associating the one of said reading devices with the specific workstation that is associated with the imaging cassette that is currently being read by the reader, said temporary association allowing the workstation to control the reader; and
sending an X-ray image data from the reader only to the specific workstation.

15. The method of claim 14 wherein any of said reading devices may send image data to any of said plurality of workstations.

16. The method of claim 14 further comprising:
releasing the reader from the associated workstation when image reading is complete.

17. The method of claim 14 wherein the temporarily associating step comprises scanning a bar code on the cassette.

18. The method of claim 14 wherein the temporarily associating step comprises scanning a bar code on the cassette and associating the bar code with the specific workstation.

19. The method of claim 14 wherein the network is a LAN.

20. The method of claim 14 wherein the network is a WAN.

21. The method of claim 14 wherein a user repositions a patient for another X-ray image while the imaging cassette with a first X-ray image is being processed by the reader.

22. A method for organizing workflow for a computed radiography system comprising a single computed radiography reader capable of receiving an imaging cassette, and a plurality of computer workstations linked to the reader, the method comprising:
temporarily associating an imaging cassette, containing a storage phosphor imaging plate, with a specific workstation;
transporting said imaging cassette to the reader;
inserting said cassette into the reader;
reading an image off of said image plate;
sending an X-ray image data from the reader to the specific workstation, wherein said workstation is located in a geographically separate location from the reader; and
releasing the reader from the associated workstation when image reading is complete, allowing said reader to be controlled by another workstation.

23. A computed radiography system comprising:
a single computed radiography reader,
a plurality of computer workstations networked to said reader;
means for temporarily associating an imaging cassette, containing a storage phosphor imaging plate, with a specific workstation;
means for temporarily associating the image plate reader with the workstation that is associated with the imaging cassette that is currently being read by the reader; and
means for sending X-ray image data from the reader only to the associated workstation.

24. The system of claim 23 further comprising:
means for releasing the reader from the associated workstation when image reading is complete.

25. The system of claim 23 further comprising:
wherein each of said workstations is located in close proximity to a radiology station, and each of said workstations may control the reader and receive image data from the reader.

26. The system of claim 23 where the means of associating an imaging plate with a workstation comprises a bar code and a bar code reader.

27. The system of claim 23 wherein the means of associating the reader with a workstation comprises:
bar code and a bar code reader;
wherein means for temporarily associating the image plate reader with the workstation comprises signaling of the workstation network such that the workstation associated with the imaging cassette being read takes control of the reader and receives image data from the reader.

28. The system of claim 23 further comprising a cassette loader coupled to said reader, said cassette loader configured to hold a plurality of imaging cassettes and automatically feed the cassettes into the reader.

29. The system of claim 23 further comprising a cassette loader coupled to said reader, said cassette loader configured to hold a plurality of imaging cassettes and automatically feed the cassettes into the reader.

30. The system of claim 23 wherein said imaging cassette includes an identifier on the cassette for use in creating a temporary association with the workstation.

31. A computed radiography system for use with an imaging cassette for use the reader, said imaging cassette having an identifier, the system comprising:
at least one computed radiography reader,
a plurality of computer workstations networked to said reader;
a scanner configured to recognize said identifier and temporarily associating the imaging cassette with a specific workstation;
a second scanner on the reader configured to recognize said identifier;
wherein said reader is configured to determine which workstation is associated with the identifier and to establish a connection with the workstation to send image data from the reader.

32. The system of claim 31 wherein the reader accesses a database to determine which workstation is associated with which cassette identifier.

33. A computed radiography system for use with an imaging cassette for use the reader, said imaging cassette having an identifier, the system comprising:
at least one computed radiography reader,
a plurality of computer workstations networked to said reader;
a processor on the reader having logic for handling image data obtained from the imaging cassette; and
a processor on each of the computer workstations having logic for receiving the image data and displaying said image on a monitor;
wherein said processor on the reader has logic for determining which of the workstations is associated with the imaging cassette and establishing a communication link with the workstation to transmit image data from the reader only to that workstation.

34. The system of claim 33 wherein the processor on the workstation has the logic to release the reader from the associated workstation with image capture at the reader is complete.

35. The system of claim 33 wherein the processor on the workstation has the logic to process bar code information received from a bar code scanner.

36. The system of claim 33 wherein the processor on the reader accesses a database to determine which workstation is associated with the imaging cassette.

37. The system of claim 33 wherein the processor on the workstation creates a dataobject in a database to associating the workstation with the imaging cassette.

38. The system of claim 33 wherein the processor on the workstation removes a dataobject in a database that associates the workstation with the imaging cassette after the reader has completed transmission of image data to the workstation.

39. The system of claim 33 wherein the processor on the workstation uses a network card in communication with the processor to broadcast an imaging cassette ID to the plurality of workstations and the workstation associated with the imaging cassette initiates image plate reading.

40. The system of claim 33 wherein the processor on the workstation uses a network card in communication with the processor to broadcast an imaging cassette ID to the plurality of workstations and the workstation with the matching bar code initiates image plate reading.

41. The system of claim 33 wherein the processor on the workstation communicates to other workstations when a new association is created for the imaging cassette and instructs other workstations to delete any associations they may have with the imaging cassette.

42. The system of claim 33 wherein the processor on the reader has logic for determining reading an age or time stamp variable associated with each association for an imaging cassette and only uses the most current association for each imaging cassette.

43. The system of claim 33 further comprising instructions for use setting forth the method as described in claim 1.

44. The system of claim 33 further comprising a kit instructions for use setting forth the method as described in claim 1 and a container for housing said instructions for use and the reader or the workstation.
